(19) United States
(12) Patent Application Publication
(10) Pub. No.: US 2008/0073281 A1
(43) Pub. Date: Mar. 27, 2008

(54) Method and Apparatus for Batch Treating Water Utilizing Magnetic Separation

(76) Inventor: Steven L. Cort, Cary, NC (US)

Correspondence Address: Coats & Bennett, PLLC/Michael deAngeli, 1400 Crescent Green, Suite 300, Cary, NC, 27581, US

(21) Appl. No.: 11/862,699

(22) Filed: Sep. 27, 2007

Related U.S. Application Data
(60) Provisional application No. 60/847,372, filed on Sep. 27, 2006.

(51) Int. Cl. B03C 1/30

(52) U.S. Cl. 210/695; 210/222

(57) ABSTRACT

A system and process for utilizing a magnetic separation technique in a batch treatment process to clarify water. The system includes a tank, a mixing device, a shearing device and magnets. Water held in the tank includes magnetic floc having magnetic seed incorporated therein. The magnetic floc settle in a lower portion of the tank and clarified water is decanted from the tank. A shearing device shears the magnetic floc producing magnetic seed and sludge. A magnetic field retains the magnetic seed while the sludge is discharged from the tank. The retained magnetic seed are reused in subsequent batches of water.

### CROSS-REFERENCE TO RELATED APPLICATION

This application claims priority under 35 U.S.C. §119(e) from the following U.S. provisional application: Application Ser. No. 60/847,372 filed on Sep. 27, 2006. That application is incorporated in its entirety by reference herein.

### FIELD OF THE INVENTION

The present invention relates to water treatment, particularly to the use of magnetic seeding and separation to clean water.

### BACKGROUND OF THE INVENTION

Briefly, “magnetic seeding and separation” technology as referred to herein involves adding a magnetic seed material to water that contains fine pollutant particles. The magnetic seed material is attached under agitation to the pollutant particles with an organic flocculating agent. The flocculated particles are now magnetic and are removed from the water with either permanent magnets or electromagnets.

A known commercial application of magnetic seeding is the “Sirofloc” technology used in Australia to clean drinking water. This process uses the absorption capacity of magnetite to remove color and other pollutants from water. The spent magnetic seed material (magnetite) settles out by gravity in a clarifier and then is pumped to a magnetite regeneration step that cleans the magnetite so it can be reused.

Another known commercial application of magnetic seeding is the “Comag” process described in Wechsler U.S. Pat. No. 6,099,738. This process has a high gradient magnetic field collector that uses powerful electromagnets. Once the collector becomes loaded with solids, it is backwashed with air and water to flush the magnetic seed material to a cleaning process. The cleaned magnetic seed material is then reused in the treatment process. The electromagnets in the Comag system have to be de-energized for cleaning. The cleaning process interrupts the flow of water for treatment and high solids loading limits the ability to backwash the system.

### SUMMARY OF THE INVENTION

The present invention relates to a method of clarifying water in a batch type water treatment system employing a magnetic separation technique. The method includes mixing magnetic seed with a flocculant to yield magnetic floc. Thereafter, the magnetic floc is settled to a lower portion of the tank and clarified water is decanted from the tank. Then, the magnetic floc are sheared producing magnetic seed and sludge. A magnetic field retains the magnetic seed in the lower portion of the tank, while the sludge is discharged from the tank. The retained magnetic seed are reused to treat subsequent batches of water.

This batch type water treatment system comprises a tank for holding water to be treated wherein the water includes magnetic floc having magnetic seed incorporated therein. A mixing device and a shearing device are disposed in the tank. Magnets are disposed adjacent a lower portion of the tank. This batch type water treatment system clarifies water using a magnetic field to magnetically remove magnetic floc from the clarified water. Once separated, the batch type water treatment system shears the magnetic floc while in the tank producing a mixture of magnetic seed and sludge. The magnetic field is further employed to retain the magnetic seed in the tank while the sludge is discharged.

### BRIEF DESCRIPTION OF THE DRAWINGS

FIG. 1 is a schematic plan view of an apparatus according to one aspect of the invention, with a magnetic separator device mounted in the upper portion of a flocculation tank.

FIG. 2 is a schematic end view of one embodiment of the magnetic separator device.

FIG. 3 is a more detailed schematic view of FIG. 2 showing a portion of a magnetic drum and scraper assembly used to first separate magnetic floc from the water stream and then to return cleaned magnetic seed to the floc tank for reuse.

FIG. 4 is a schematic side view of a tank and related equipment for carrying out the method of the invention.

FIGS. 5a, 5b and 5c, show details of scraper designs.

FIG. 6 is a schematic illustration of a batch treatment system showing a flocculation phase of a magnetic separation process.

FIG. 7 is a schematic illustration showing magnetic floc settled to the lower portion of the tank.

FIG. 8 is a schematic illustration showing clarified water being decanted from the tank.

FIG. 9 is a schematic illustration showing magnetic floc being sheared yielding magnetic seed and sludge.

FIG. 10 is a schematic illustration showing sludge being drained from the tank, while the magnetic field retains the magnetic seed in the tank.

FIG. 11 shows the magnetic seed retained in the tank after the sludge has been drained.

### DETAILED DESCRIPTION OF THE INVENTION

The present invention is in the technical field of removing fine particles from water. The fine particles can include metal precipitates, organic solids, inorganic solids, clays, silts, oil and grease and any other hard to remove fine solids. The invention is applicable to industrial wastewater, municipal wastewater, potable water, combined sewer overflow, storm water, process water, cooling water, ground water, and any other waters that require clarification to remove fine particles. The term “water” as used herein includes water and all forms of wastewater.

The invention relates to the use of magnetic seeding and separation technology where a fine magnetic seed material is added to the water along with an organic flocculating polymer. The organic flocculating polymer binds the non-magnetic pollutant particles to the magnetic seed material and then the composite particle, or magnetic floc. In some embodiments, a flocculating polymer may not be used but rather the sorption properties of the magnetic particles are employed to extract pollutants from the water and attachë the pollutants to the magnetic particles. In some cases, certain scalants may be removed by employing magnetic particles whose surfaces provide sites for sacrificial scaling thus preventing or reducing scaling on downstream equipment. In any case, the invention includes utilizing the magnetic properties of the magnetic particles, bound with pollutants—be they in the form of flocs, particles with pollutants sorbed therewith, or scaled magnetic particles—to magnetically remove the pollutants from the water.

Collectors employing magnetized surfaces are used to attract magnetic particles and their burden of pollutants. The magnetized surfaces are generally moving magnetized surfaces to facilitate continuous transport of collected particles out of the water. The surfaces are equipped with permanent magnets or electromagnets to provide the required magnetic strength to remove the magnetic particles. The magnetic strength of the magnets used ranges approximately 0.1 to 10 tesla. Permanent magnets may be more commonly 0.5 to 1.5 tesla while electromagnets may be configured with a strength up to about 10 tesla.

The magnetically collected magnetic floc are further processed to form separate streams of sludge to be ejected as a waste product and cleaned magnetic seed to be recycled and reused in the water treatment system.

The process of using magnetic seeding and separation technology for removing fine pollutant particles sometimes involves attaching the fine pollutant particles to the magnetic seed material with a flocculating polymer. In a traditional flocculation process, the aim is to produce a large floc that will settle rapidly by gravity. To assure this floc formation, it is important to have the proper mixing energy. The measure of this mixing energy is referred to as the root-mean-square velocity gradient G measured in negative seconds (sec⁻¹). For optimum floc formation in a gravity separation situation, the G value should generally not exceed approximately 50 sec⁻¹. Exceeding this level increases the speed of mixing and the formation of microfloc, but will shear the floc and prevent the development of large macroflocs that will settle rapidly.

Magnetic seeding and separation is different. Since the size of floc is not important because gravity settling is not employed, the G value can be greatly increased because all that is needed is for the magnetic and non-magnetic particles to collide quickly in the presence of the flocculating polymer. Therefore the G value can be increased to about 100 sec⁻¹ and higher, which will speed the flocculation and therefore clarification process. The G value should generally be greater than about 50 sec⁻¹ and less than about 1000 sec⁻¹ but more preferably in the range of about 100 to about 500 sec⁻¹ in magnetic seeding and separation.

Various forms of magnetic seed material may be used. Among the forms is magnetite, a ferromagnetic form of ferric oxide. Other forms include but are not limited to zero valent iron, ferrosilicon, maghemite, jacobsite, trevorite, magnesioferrite, magnetic sulfides like pyrrohotite and greigite, and any other ferromagnetic and ferremagnetic materials that show strong attraction to a magnetic field.

Magnetic seed particle sizes in the range of 30 to 50 microns, as would be characteristic of 90% of material passing a 355 mesh, may be commonly used as magnetic seed for binding or sorbing pollutant particles for removal. Further, for various sorption processes, those that for example may be useful for removing very fine or nano pollutant particles, magnetic seed sizes may range down to approximately 20 nanometers. Magnetic seeding in treatment vessels such as flocculation tanks is typically done at a concentration by weight of magnetic seed of about 0.5 to 1% and which in some cases may up to about 3-5%.

### Tank Design

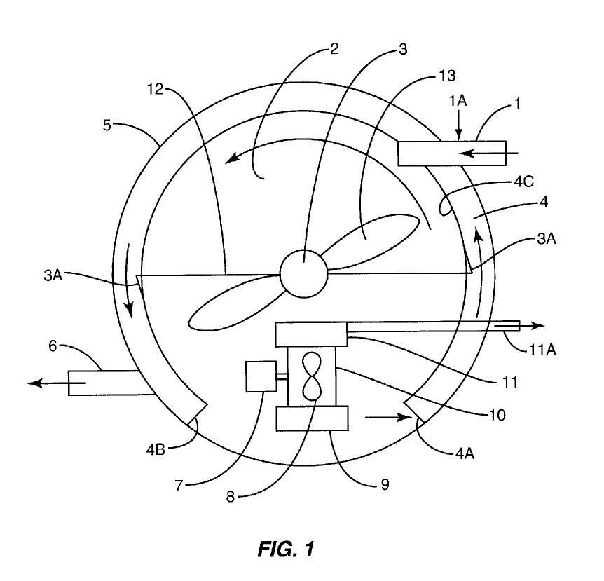

With reference to the drawings, a final magnetic collector 4 is configured to maximize the residence time in the flocculation chamber while maximizing the surface area of the final magnetic collector. One way to do this is to locate the floc chamber in the center and bottom of a cylindrical tank and then to extend the final collector around the perimeter of the upper regions of the tank, as illustrated in FIG. 1. In this way, the floc chamber occupies a maximum volume of the tank, increasing the residence time during which the flocculent effectively attaches fine pollutant particles to the magnetite, or magnetic seed to form composite particles or magnetic floc. This allows the use of magnetic techniques for removal of the fine pollutant particles from the water stream.

The tank can be a circular cylindrical tank with a circular final magnetic collector 4 extending around the perimeter of an upper portion of a treatment tank 5, as illustrated in FIG. 1. Disposing final magnetic collector 4 around the perimeter of tank 5 maximizes the surface area of the collector, effectively slowing the motion of the composite particles to less than 18 inches per second and increasing their residence time in the collector. A speed faster than 18 inches per second will tend to dislodge the magnetic particles from magnetized surfaces of final magnetic collector 4.

Scaling up the tank design for high flow rate applications requires a larger final magnetic collector 4 which is most easily accommodated by placing it in proximity to the perimeter of the tank 5. The efficiency of final magnetic collector 4 is reported as the Surface Overflow Rate (SOR) which is measured in gallons per minute per square foot (gpm/ft²) of surface area. The SOR for a traditional gravity clarifier is 0.25 to 1.00 gpm/ft². The SOR for the present invention ranges from 10 gpm/ft² to 300 gpm/ft² which makes magnetic separation technology more effective than gravity clarification.

FIG. 1 shows a typical layout for positioning of key treatment elements. The important features include provision of a cylindrical tank 5 which is strong and easy to construct, whereby a large portion 2 of the tank volume is dedicated to the flocculation of pollutants to magnetic seed material, and provision of a long flow path for a final magnetic collector 4. In some applications, a square or rectangular tank may be utilized in the process since a final magnetic collector 4 can be configured such that it can be disposed along one side of the tank. See, for example, the description here below of a magnetic belt collector. While more expensive to construct, a square tank has some improved flocculation characteristics because of improved mixing in that it does not require baffles to increase turbulence as may sometimes be the case with circular tanks.

Referring in particular to FIG. 1, water flows into the tank through a pipe 1 where flocculating polymer 1A is added. The water flows into a central flocculation chamber 2 that contains magnetic seed particles (typically magnetite), so that composite magnetic particles, or magnetic floc, formed are made up of the pollutant particles bound by the flocculent to the magnetic seed. A flocculation mixer motor 3 and mixer blade 13 are provided to ensure thorough mixing. Water then flows through an opening 4A into an outer shell which contains a final magnetic collector 4 that extends about the perimeter of the tank 5. In this space any of a variety of different types of final magnetic collectors 4 can be installed. In one embodiment, the magnetic seed material or particles will be collected along an inner magnetized surface 4E closest to the flocculation chamber 2 and moved by a mechanical scrapers 3A disposed on ends of arms12 driven by flocculation motor 3. Clarified water overflow out pipe 6 while scrapers 3A urge magnetically collected seeded floc along surface 4E and one to drum 9 of a magnetic seed cleaning system disposed in tank 5. A motor 7 drives two magnetic drum devices 9 and 11. The first magnetic drum 9 collects magnetic floc and directs the magnetic floc to a shear device or tank 10 that includes a shear mixer 8 that shears the magnetic particles away from the non-magnetic pollutant particles producing a slurry of magnetic seeds and sludge. These materials are separated magnetically on drum 11 with the magnetic seed material going back into the flocculation chamber for reuse and the non-magnetic pollutants, or sludge, being discharged for disposal 11A. The location of the first magnetic drum 9 can be advantageously placed in front of the opening 4A so that is removes magnetic particles before they reach the final magnetic collector 4 as well as receiving scraped floc from the final collector. This dual duty for the first magnetic drum or collector 9 reduces the solids loading on the final magnetic collector 4. The first magnetic collector 9 that removes the magnetic floc for seed separation and cleaning is typically shown as a magnetic drum but can be in other configurations.

### Horizontal Shear Device

A first magnetic drum collector is used to collect the composite magnetic particles, or magnetic floc, comprising the pollutants to be removed, the flocculant, and the magnetic seeds. The first magnetic drum collector or a second magnetic drum collector can be used clean the pollutant and flocculant from the magnetic seed material so the seeds can be reused. For example, a first magnetic drum rotating about a horizontal axis is submerged into the floc tank where the first magnetic drum collects the composite magnetic floc. Typically, the magnetic floc is scraped off the magnetic drum into a vertical shear tank where fine pollutant particles are detached from the magnetic seed by a vigorous mixing action. The clean magnetic seed is then collected on a second magnetic drum collector and scraped back into the floc tank.

Mounting the shear tank in a vertical position causes a surging in the tank, especially if the tank is square, when the magnetic floc is scraped into the tank. This surging action causes an uneven amount of magnetic seed to be deposited on the second magnetic drum collector. There are also some layout problems caused by use of a vertical shear tank; notably, if a relatively wide first magnetic drum collector is used for removing magnetic floc from the floc tank, it will not match up well to a much narrower vertical shear tank. A better configuration is to mount the shear tank in a horizontal position, parallel to the first magnetic drum collector, and to make the shear tank of similar width to the first and second magnetic drum collectors. Doing so also avoids the surging found in a vertically mounted shear tank.

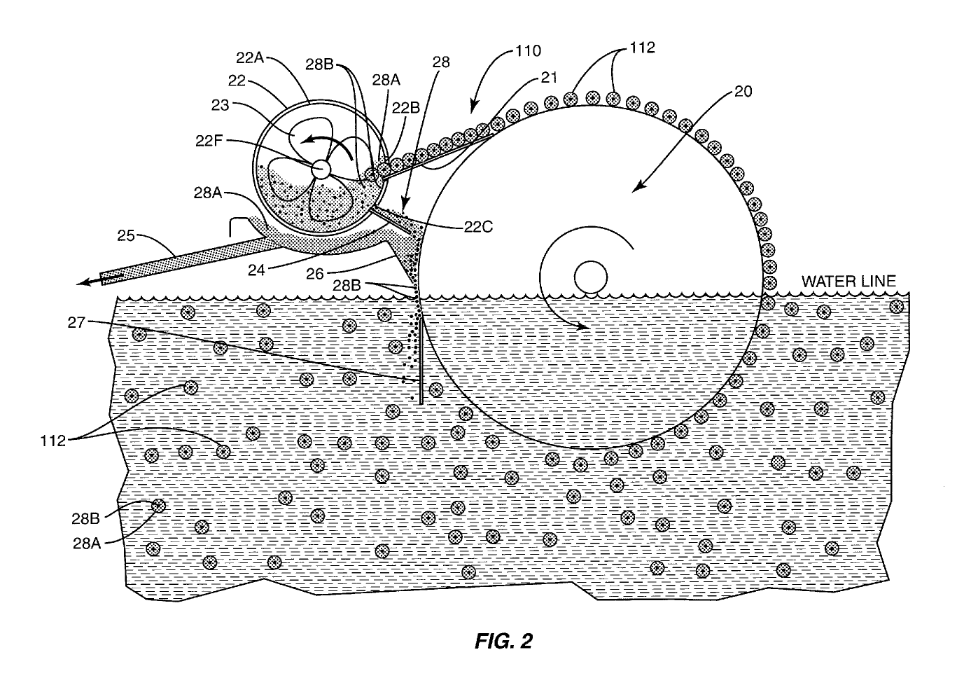

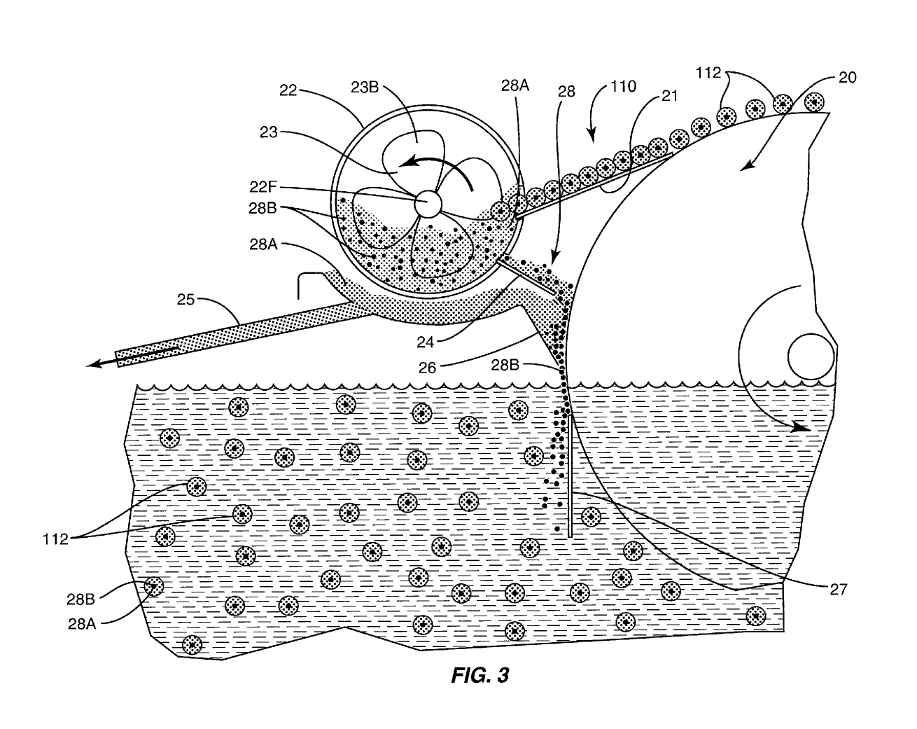

FIG. 2 shows a horizontal shear tank 22 juxtaposed to a rotating magnetic drum 20 which removes composite magnetic particles from the flocculation chamber for cleaning the pollutant particles and flocculant from the magnetic seed particles. The composite particles 112 are scraped from the surface of drum 20 by a scraper 21 and flow in the form of a swath 110 down its upper surface into the horizontal shear tank 22. Inside this tank is a high-shear powerful mixer 23 that causes separation of the magnetic seed magnetite, for example from the pollutant particles. The sheared slurry flows out of the tank 22 through a slot onto a trough 24 and back onto the magnetic drum 20. The magnetic particles are attracted to the surface of the drum 20, while a scraper 26 pressing against the magnetic drum 20 causes the water that contains the pollutants to overflow into a discharge pipe 25 for disposal. See FIG. 3 for an enlarged view. The pressed magnetic seed is then scraped 27 off the magnetic drum so the magnetic seed can be returned to the floc chamber to be reused.

### Magnetic Drum Design

The goal is to use only one magnetic collector to remove magnetic floc from the floc tank and return cleaned magnetic seed into the floc tank. Magnetic floc collected on the magnetic collector are scraped off by a first removal device, or scraper, and transferred into a shearing device. The shearing device shears the magnetic flocs to free the magnetic seed from the floc, producing a slurry of magnetic seeds, flocculant, and pollutants, the flocculant and pollutants essentially forming a sludge It is necessary to separate the magnetic seed from the sludge so the magnetic seed can go back into the floc tank for re-use, while the separated sludge is disposed. It was observed that a blade, or retainer, pressing against the magnetic drum will squeeze or compress the magnetic seed together, urging any remaining sludge away from the seed and leaving the seed substantially dry. The sludge will then overflow over the blade, or retainer, to be discharged, while the compressed and substantially dry magnetic seed will be removed by another scraper and returned to the floc tank for re-use. This approach employs the same magnetic collector to remove magnetic floc from the water and to separate the magnetic seed from the sludge after shearing. One magnetic drum is eliminated, which reduces cost, space requirements, and mechanical complexity of the system.

FIG. 3 shows an enlarged detail of FIG. 2, illustrating the manner in which magnetic seed is separated from non-magnetic pollutants. Sheared sludge, referred to sometimes as a sheared slurry of magnetic seeds a sludge, exits through a slot in the horizontal shear tank 22 which contains a shear mixer 23 and flows down a trough24 back onto the surface of the same rotating magnetic drum 20 that first removed the dirty sludge from the flocculation tank. The magnetic material adheres to the drum and is collected in a wedge-shaped collection area formed by a retainer or trough 26 extending along the surface of the drum 20. The lower end of trough 26 is spaced close to the surface of drum 20, so that it squeezes out water that contains the non-magnetic pollutants while the separated magnetic seed material is attracted to and retained on the surface of the drum 20. The retainer 26 prevents the non-magnetic slurry from going back on the drum and into the flocculation chamber. Rather the slurry overflows the retainer 26 into a sludge collector comprising a discharge pipe 25 for disposal. The magnetic seeds that adhered to the magnetic drum 20 are scraped off its surface by a scraper 27, and drops back into the flocculation chamber for reuse.

### Magnetic Separation as a Batch Process

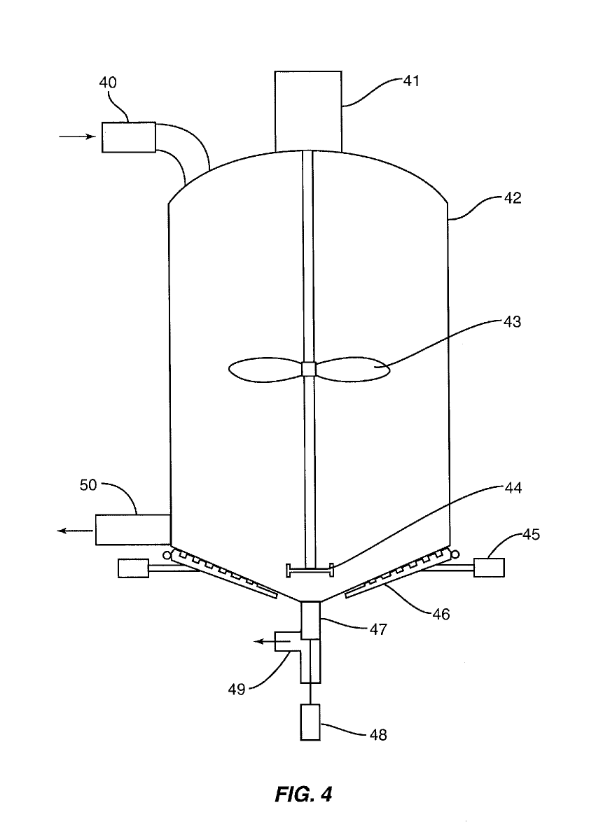

Magnetic separation systems have typically involved continuous flow applications. In the case of the magnetic batch system shown in FIGS. 4 and 6-11, all treatment functions are carried out in the same tank, using a single variable speed motor and a mixing and shearing assembly.

With reference to FIG. 4, a batch treatment system is shown therein and comprises a non-ferromagnetic tank 42 that includes a bottom, sidewall structure, and a top. A variable speed motor 41 drives a central shaft that has secured thereto a mixing blade 43 and a shearing blade 44. An inlet 40 permits water to be treated to enter the tank 42. An outlet 50 is disposed about a lower portion of the tank 42 for discharging treated water. As seen in FIG. 4, the bottom of the tank 42 slopes inwardly and downwardly to a central area where there is provided a valve 47 for discharging sludge from the tank 42. Valve 47 is actuated by an operator or actuator 48.

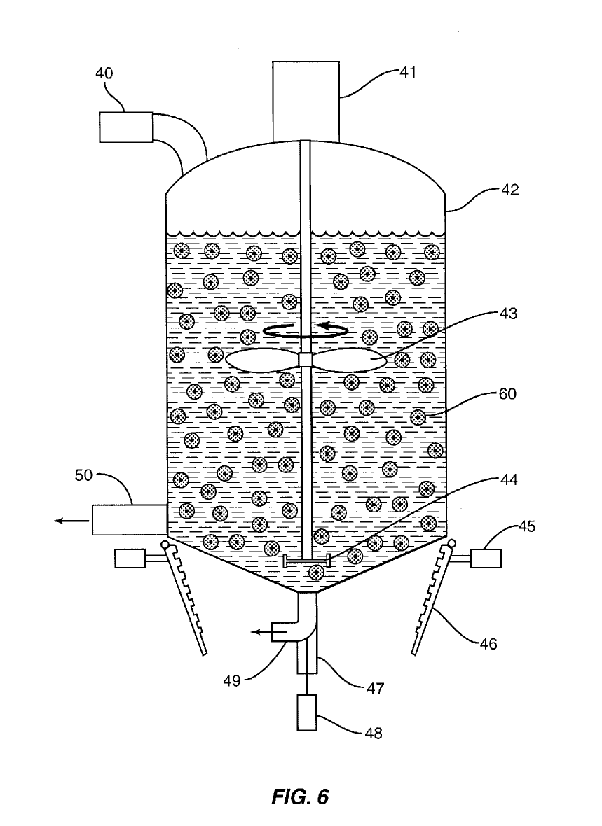

As noted above, the batch treatment system shown in FIG. 4 employs magnetic seeding and magnetic separation. To accomplish magnetic separation, the batch treatment system is provided a plurality of magnets 46. In the case of the embodiment illustrated herein, the magnets 46 are permanent magnets, but it is understood that other types of magnets could be used, such as electromagnets. To move the magnets 46 between the operative position shown in FIG. 4 and the inoperative position shown in FIG. 6, there is provided a series of air cylinders 45. Each cylinder is operative to move a magnet from a position relatively close to the bottom of the tank 42 to a position away from the bottom of the tank.

To treat water with the batch treatment system shown in FIG. 4, the tank 42 is charged with contaminated water by directing the water into inlet 40. Magnetic seed, such as magnetite, is either present from a prior process or is added. Once the tank 42 is filled, a flocculant is added and functions to attach pollutant particles to the magnetic seed. In one embodiment, mixer 41 is operated at a relatively slow speed to ensure good mixing while avoiding shearing of the magnetic floc that are being formed in the tank. During this flocculation phase of the batch treatment process, the magnets 46 are inoperative, as shown in FIG. 6. The gentle mixing by the mixing blade 43 causes suspended solids, and particulate matter in general, to agglomerate around the magnetic seed to form the floc indicated by the numeral 60.

After sufficient flocculation has occurred, the floc 60 are settled to the bottom of tank 42. Settlement can be achieved in various ways. In one embodiment, the motor 41 is turned off and the magnetic floc 60 is allowed to settle by gravity to the bottom of the tank 42. In another embodiment, the motor 41 is operated at a relatively slow speed, thereby providing gentle mixing, and the magnets 46 are positioned closely adjacent the bottom of the tank 42 and the magnetic attraction caused by the magnets 46 causes the magnetic floc 60 to settle to the bottom of the tank. In this embodiment, the magnetic field applied by the magnets 46 attract the magnetic floc to the lower collection surface of the tank 42.

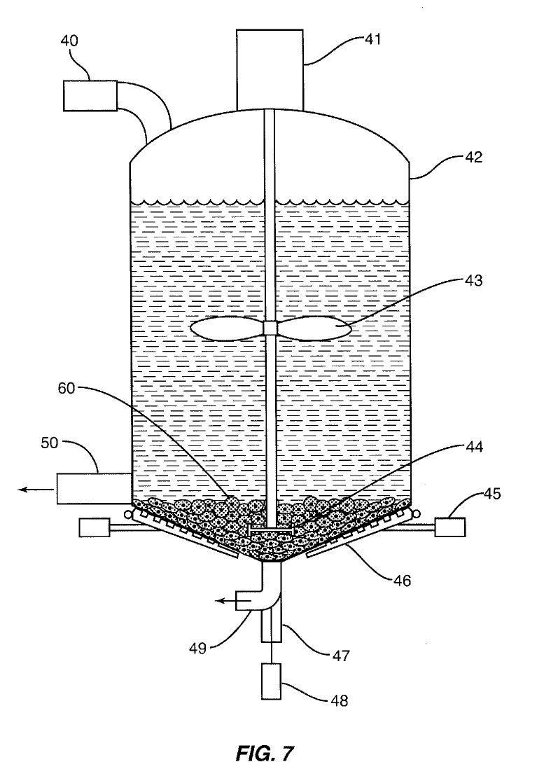

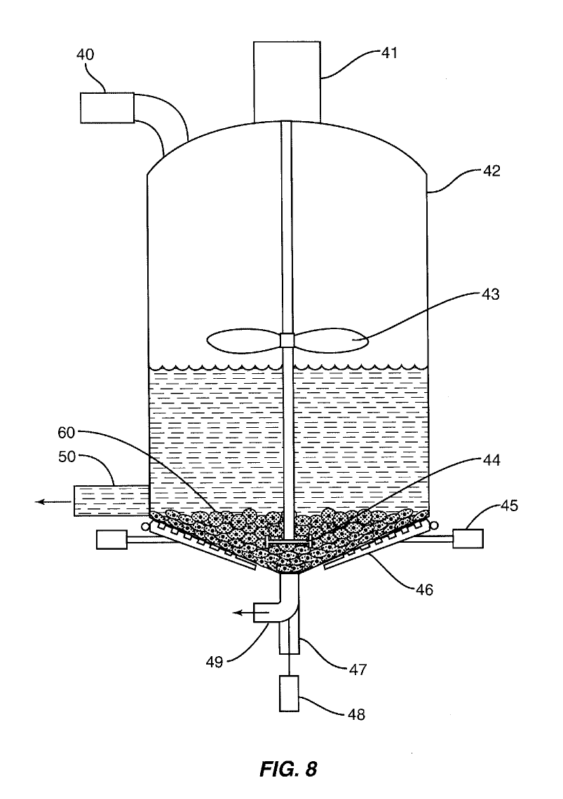

FIG. 7 shows the magnetic floc settled in the lower portion of the tank 42. At this point, a valve associated with outlet 50 can be actuated and the clarified water in the tank 42 can be discharged through the outlet 50. This is illustrated in FIG. 8. While the water is being discharged out outlet 50, the magnets 46 are disposed in their operative position and function to retain the magnetic floc about the lower portion of the tank while clarified water is being decanted through line 50.

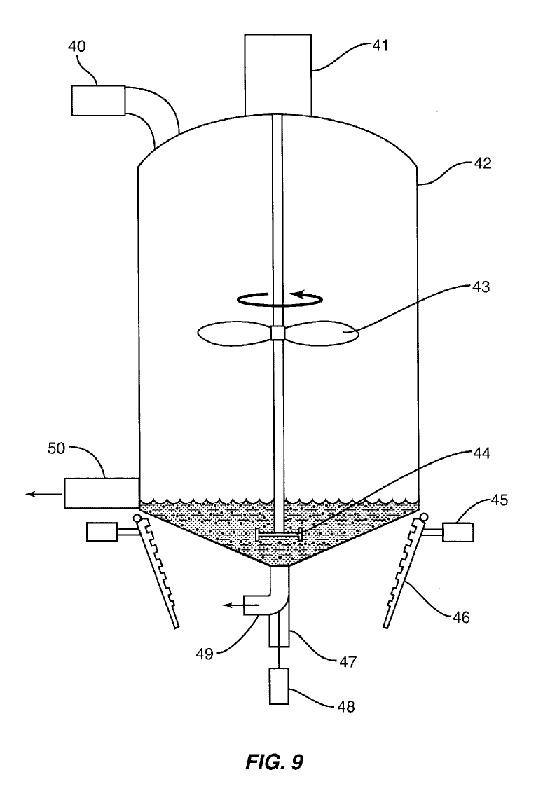

Once the clarified water has been decanted from the tank 42, the magnets 46 are moved to their inoperative position shown in FIG. 9, and the motor 41 is driven at a relatively high speed. During this phase of the process, the shearing blade 44 disposed about the lower portion of the central shaft, engages and shears the magnetic floc in the lower portion of the tank. This shearing action, shears the magnetic seed from the particulate matter surrounding the same. Effectively, this shearing action separates the magnetic seed from sludge.

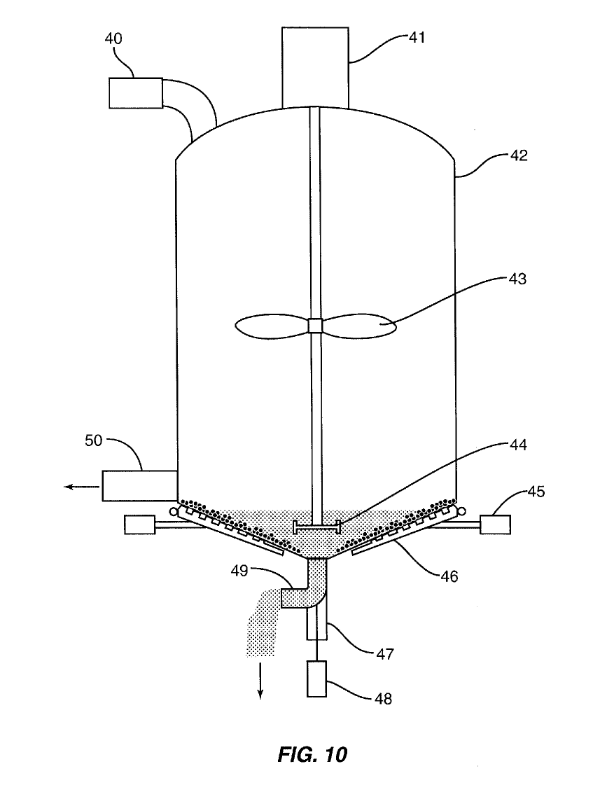

Once the shearing phase of the batch process is completed, the magnets 46 are moved back to their operative position, a position relatively close to the bottom of the tank 42. This is illustrated in FIG. 10. Now the separated sludge can be discharged out outlet of 49. In this phase of the process, the motor 41 may be driven at a relatively slow speed and valve 47 is open to permit the sludge to be discharged out the sludge outlet 49. It may not be essential to drive the shear blade 44 while discharging the sludge out outlet 49. However, some gentle agitation of the sludge in the lower portion of the tank 42 may facilitate the discharge of sludge through outlet 49. While the sludge is being discharged out outlet 49, the magnets 46 retain the separated magnetic seed in the tank 42 and generally in close proximity to the bottom surface thereof.

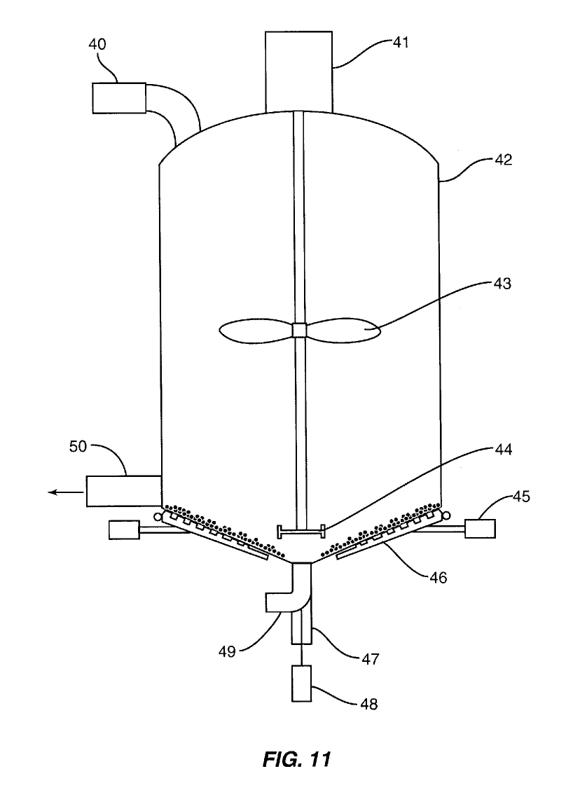

Once the sludge has been discharged, the magnetic seed remains in the bottom of the tank 42. This is illustrated in FIG. 11. Now the batch process can be repeated by closing valve 47 and introducing a new batch of water to be treated through inlet 40. Again, a flocculant is added, and from time-to-time, additional magnetic seed, such as magnetite, may be added in order to provide for efficient and effective flocculation.

### Scraper Design

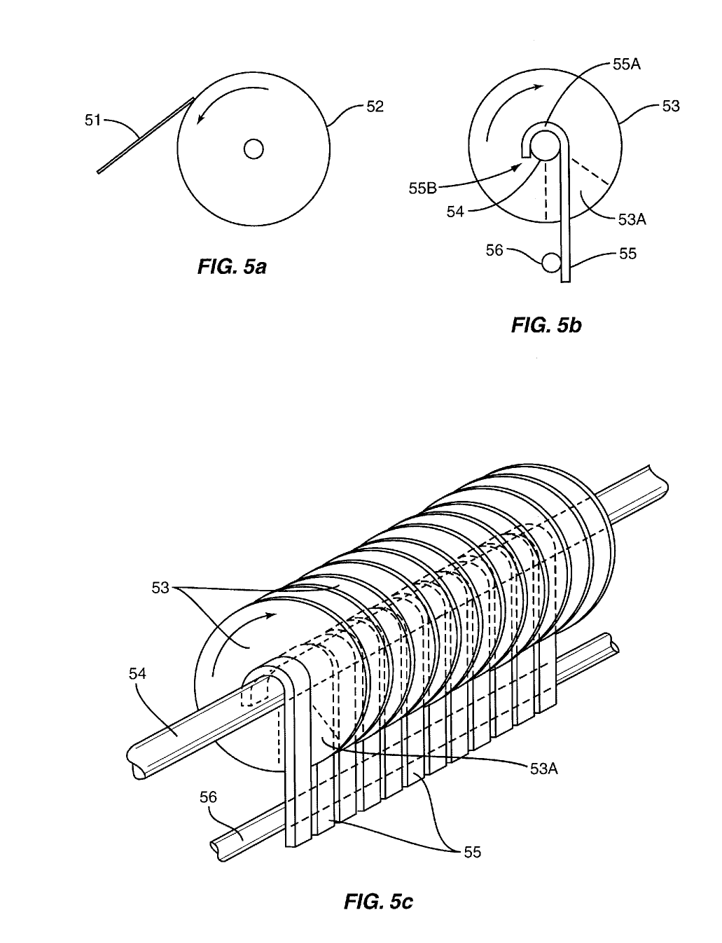

FIG. 5a shows a removal device or scraper 51 that includes a ferromagnetic material disposed such that the scraper is attracted to a magnetic drum 52 to remove collected magnetic floc from the drum. A magnetic attraction, or force, acts between drum 52 and scraper 51, and maintains a constant pressure between the drum and the scraper 51 over the entire length of the scraper, thus providing good scraping efficiency. This also provides a self adjusting feature to allow compensation for wear. The magnetic attraction, or force is independent of wear of the drum 52 or the scraper 51. Thus as either the drum 52 or the scraper 51 wears, the scraper is kept in contact with the drum with essentially the same force. Moreover, the magnetic force has an intensity that is generally constant over the area of contact or approach between the scraper 51 and the drum 52. This facilitates maintaining uniform contact over the area of contact or approach. This uniform contact is also therefore obtainable even in cases where the scraper 51 or drum 52 wears in a pattern that produces irregularities in the contact area. This design enhances the consistent and continuous cleaning of permanent magnet collectors.

It should be noted, that scraper 51 also functions to convey removed magnetic floc from the magnetic drum 52. That is, since scraper 51 is magnetically held adjacent to or in contact with the magnetic drum 52, magnetic floc scraped from the drum 52 tends to move down the upper surface of scraper 51. Thus, scraper 51 not only removes the magnetic floc from magnetic drum 52, but also directs or channels the removed magnetic floc away from the magnetic drum. As discussed elsewhere herein, the removed magnetic floc is typically directed to a shear device where the magnetic floc is sheared producing magnetic seed and sludge.

FIGS. 5b and 5c show a removal device or scraper 55 that can be easily removed and which does not impede the flow of water between disks of a rotary magnetic collector that is disposed in a tank of water to collect magnetic floc. A plurality of scrapers 55 is preferably disposed between adjacent disks 53, so as to engage and scrape magnetic flocs from the opposed faces of the adjacent disks. Each scraper 55 has a hook end 55A by which it is suspended from a center shaft 54 holding the disks of the magnetic collector. An opening 55B formed by hook end 55A facilitates easy installation and removal of the scraper from above the magnetic collector for convenience. Preferably, the magnets are maintained stationary on disk (not shown) sandwiched between two plastic, or other non-magnetic material-based, rotating disks. Typically, magnets are omitted from a lower sector of the disks, forming a magnet-free sector 53A on each disk. This facilitates magnetic floc detaching at sector 53A of the disk surface where the scrapers 55 are be located. The scrapers 55 extend radially beyond the magnetic collection disks so that they can engage a stop or retaining bar 56 that prevents each scraper from moving out of the magnet-free sector 53A at the bottom of the magnetic collection disks. This scraper 55 is hung from the center shaft 54 of the disk collector and mounted in a vertical position so it does not impede the flow of water through the magnetic disk collector. In one embodiment, the general direction of flow is generally parallel to scrapers 55. Each space between disks includes one scraper, which can be arranged to scrape the opposed surfaces of adjacent disks.

The present invention may, of course, be carried out in other specific ways than those herein set forth without departing from the scope and the characteristics of the invention. The present embodiments are therefore to be construed in all aspects as illustrative and not restrictive and all changes coming within the meaning and equivalency range of the appended claims are intended to be embraced therein.

1. A method of removing solids from water comprising:
a. mixing magnetic seed, a flocculant and water in a tank to form magnetic floc;
b. settling the magnetic floc in a lower portion of the tank;
c. decanting purified water from the tank;
d. shearing magnetic floc in the lower portion of the tank, producing magnetic seed and sludge; and
e. magnetically retaining magnetic seed in lower portion of the tank while discharging the sludge from the tank.

2. The method of claim 1 including agitating the magnetic seed and the sludge and magnetically retaining the magnetic seed and discharging the sludge

3. The method of claim 1 wherein the steps of mixing and shearing is performed by at least one mixing blade and at least one shearing blade driven by a common shaft.

4. The method of claim 1 including disposing one or more magnets adjacent the lower portion of the tank such that the one or more magnets are operative to retain the magnetic seed in the lower portion of the tank while sludge is being discharged.

5. The method of claim 1 including a rotating shaft disposed in the tank and having at least one mixing blade and one shearing blade secured thereto; the method including varying the speed of the shaft during two or more steps of the method.

6. The method of claim 5 including driving the mixing blade relatively slow when mixing the magnetic seed and flocculant to form the magnetic floc; and driving the shearing blade relatively fast when shearing the magnetic floc.

7. The method of claim 1 wherein settling the magnetic floc in a lower portion of the tank includes magnetically attracting the magnetic floc to a lower portion of the tank.

8. The method of claim 7 including continuing to mix the contents of the tank while magnetically attracting the magnetic floc towards the lower portion of the tank.

9. The method of claim 1 including providing the tank with a mixer for mixing the magnetic seed and flocculant to form the magnetic floc, and wherein the method includes turning the mixer off and settling the magnetic floc by gravity.

10. A batch type water treatment system that utilizes magnetic separation to clarify water, the system comprising:
a. a tank for holding the water to be treated wherein the water includes magnetic floc having magnetic seed incorporated therein;
b. at least one mixing device disposed in the tank;
c. at least one shearing device disposed in the tank; and
d. one or more magnets disposed adjacent a lower portion of the tank for attracting magnetic seed to the lower portion of the tank.

11. The water treatment system of claim 10 wherein one or more of the magnets are disposed exteriorly of the tank.

12. The water treatment system of claim 10 wherein the tank includes an outlet for decanting clarified water from the tank.

13. The water treatment system of claim 10 wherein the tank includes an outlet for discharging sludge from the tank.

14. The water treatment system of claim 10 wherein the tank includes one or more fluid cylinders for moving the one or more magnets back and forth with respect to the lower portion of the tank.

15. The water treatment system of claim 10 wherein the tank includes a bottom having a central area and which slopes upwardly from the central area; and an outlet for discharging sludge extending from the bottom central area of the tank.

16. The water treatment system of claim 10 wherein the mixing device includes a mixing blade and the shearing device includes a shearing blade; and wherein the mixing blade and shearing blade are secured to a common shaft disposed in the tank, with the shearing blade being disposed below the mixing blade.

17. The water treatment system of claim 10 including a shaft extending through the tank and a variable speed electric motor operatively connected to the shaft for driving the same; a mixing blade secured intermediately to the shaft and a shearing blade secured to a lower portion of the shaft and disposed in the lower portion of the tank.

18. The water treatment system of claim 10 including at least one magnet movably mounted adjacent the bottom of the tank and wherein the magnet is movable between an operative position where the magnet is disposed closely adjacent the bottom of the tank in an inoperative position where the magnet is spaced from the bottom of the tank.

19. The batch type water treatment system of claim 10 wherein the tank is constructed of a non-ferromagnetic material.

20. The method of claim 1 including mixing the magnetic seed, flocculant, and water in a non-ferromagnetic tank.
